(19) United States
(12) Patent Application Publication
(10) Pub. No.: US 2022/0144215 A1
(43) Pub. Date: May 12, 2022

(54) WIPER CONTROL METHOD AND DEVICE

(71) Applicant: ZTE CORPORATION, Shenzhen (CN)

(72) Inventor: Yilei ZHANG, Shenzhen (CN)

(21) Appl. No.: 16/316,533

(22) PCT Filed: Oct. 20, 2016
(86) PCT No.: PCT/CN2016/102761

§ 371 Date: Jan. 9, 2019

(30) Foreign Application Priority Data
Jul. 8, 2016 (CN) 201610539658.9

(51) Int. Cl. B60S 1/08

(52) U.S. Cl. CPC B60S 1/0818; B60S 1/0807

(57) ABSTRACT

Disclosed a wiper control method and device, the method including: setting a plurality of wiper control policies, the plurality of wiper control policies at least including a control according to a detection result of a rainfall detection unit and a control according to a wiper control parameter sent by a mobile terminal; and selecting one wiper control policy to control a swing state of the wiper according to a preset condition.

### CROSS-REFERENCE TO RELATED APPLICATION

This application is the 371 application of PCT Application No. PCT/CN2016/102761, filed Oct. 20, 2016, which is based upon and claims priority to Chinese Patent Application No. 201610539658.9, filed Jul. 8, 2016, the entire contents of which are incorporated herein by reference.

### TECHNICAL FIELD

The present disclosure relates to the field of automobile parts technologies, and more particularly, to a wiper control method and device.

### BACKGROUND

Automobiles are common means of transportation for people to travel. When raining, people will start the wiper to remove the rain from the glass when driving on the road to facilitate the driver to see the road conditions clearly. When starting the wiper, the wiper is started manually at present, and the wiper works for a fixed period each time. Due to the lack of flexibility and humanization of the existing wiper control manner, the wiper cannot be adjusted reasonably according to the rainfall, so that the driver cannot may not accurately judge the road conditions when driving in the rain, thus causing a lot of inconveniences and troubles to the driver.

This section provides background information related to the present disclosure which is not necessarily prior art.

### SUMMARY

A wiper control method and a wiper control device provided by the embodiments of the present disclosure mainly solve the technical problem that the existing wiper is not flexible and humanized due to manual moving.

In order to solve the foregoing technical problem, the embodiments of the present disclosure provide a wiper control method, including:

setting a plurality of wiper control policies (i.e., steps or instructions), the plurality of wiper control policies at least including a control according to a detection result of a rainfall detection unit and a control according to a wiper control parameter sent by a mobile terminal; and

selecting one wiper control policy to control a swing state of the wiper according to a preset condition.

The embodiments of the present disclosure provide a wiper control device, including:

a policy setting module configured to set a plurality of wiper control policies, the plurality of wiper control policies at least including a control according to a detection result of a rainfall detection unit and a control according to a wiper control parameter sent by a mobile terminal; and

a wiper control module configured to select one wiper control policy to control a swing state of the wiper according to a preset condition.

The embodiments of the present disclosure provide a wiper control device, including: a controller, a rainfall detection unit and a wireless connection unit, the controller being respectively connected with the rainfall detection unit and the wireless connection unit; and

the controller being configured to set a plurality of wiper control policies, the plurality of wiper control policies at least including a control according to a detection result of the rainfall detection unit and a control according to a wiper control parameter sent by a mobile terminal; and also configured to select one wiper control policy to control a swing state of the wiper according to a preset condition.

According to another embodiment of the present disclosure, there is also provided a storage medium. The storage medium is configured to store program codes for executing the following steps:

setting a plurality of wiper control policies, the plurality of wiper control policies at least including a control according to a detection result of a rainfall detection unit and a control according to a wiper control parameter sent by a mobile terminal; and selecting one wiper control policy to control a swing state of the wiper according to a preset condition.

Optionally, the storage medium is also configured to store program codes for executing the following steps:

detecting the rainfall through the rainfall detection unit; determining whether the rainfall satisfies a set threshold according to the detection result; and when the rainfall satisfies the set threshold, proceeding the step of controlling the swing state of the wiper according to the detection result of the rainfall detection unit.

Optionally, the storage medium is also configured to store program codes for executing the following step:

detecting at least one of a raindrop weight and a raindrop density through the rainfall detection unit to determine the rainfall.

Optionally, the storage medium is also configured to store program codes for executing the following steps:

acquiring the wiper control parameter sent by a user through the mobile terminal; or, receiving the wiper control parameter sent by the mobile terminal, the wiper control parameter being a parameter acquired according to the detection result of the rainfall detection unit.

The present disclosure has the beneficial effects as follows:

According to the wiper control method, the wiper control device and the computer storage medium provided by the embodiments of the present disclosure, the plurality of wiper control policies are set, the plurality of wiper control policies at least including a control according to the detection result of the rainfall detection unit and a control according to the wiper control parameters sent by the mobile terminal; then, one wiper control policy is selected to control the swing state of the wiper according to the preset condition. By implementing the wiper control mode provided by the embodiments of the present disclosure, the wiper can be adjusted adaptively according to the rainfall, and meanwhile, the wiper control mode is more flexible and humanized by providing various wiper control policies for users. In addition, the wiper control device provided by the embodiments is simple and convenient, and can be arranged at front and rear windows, side windows and other places of the automobile, providing a clearer view for the user, and further ensuring that the user can accurately judge the road conditions when driving in the rain, thereby improving the use experience of the user.

This section provides a summary of various implementations or examples of the technology described in the disclosure, and is not a comprehensive disclosure of the full scope or all features of the disclosed technology.

### BRIEF DESCRIPTION OF THE DRAWINGS

The accompanying drawings illustrated here serve to provide a further understanding of the invention and constitute a part of the application, and the illustrative embodiments of the invention and together with the description thereof serve to explain the invention, and do not constitute inappropriate definition to the invention. In the drawings:

FIG. 1 is a flow chart of a wiper control method provided by a first embodiment of the present disclosure;

FIG. 2 is a schematic diagram of an application software control interface provided by the first embodiment of the present disclosure;

FIG. 3 is a schematic diagram of a wiper control device provided by a second embodiment of the present disclosure;

FIG. 4 is a schematic diagram of a wiper control device provided by a third embodiment of the present disclosure; and

FIG. 5 is a flow chart of selecting a control mode provided by a fourth embodiment of the present disclosure.

### DETAILED DESCRIPTION

The embodiments of the present disclosure will be further described hereinafter in detail with reference to the drawings and specific embodiments.

### First Embodiment

In order to solve the technical problems of poor control flexibility and lack of humanization caused by the manual moving of the existing wiper, an embodiment of the present disclosure provides a wiper control method, which controls a swing state of the wiper by setting a plurality of wiper control policies and then reasonably selecting one wiper control policy according to a preset condition, so that a user can obtain better use experience, and can select wiper control mode more flexibly to obtain a clearer view at the same time, so that the user can accurately judge the vehicle conditions when driving in the rain.

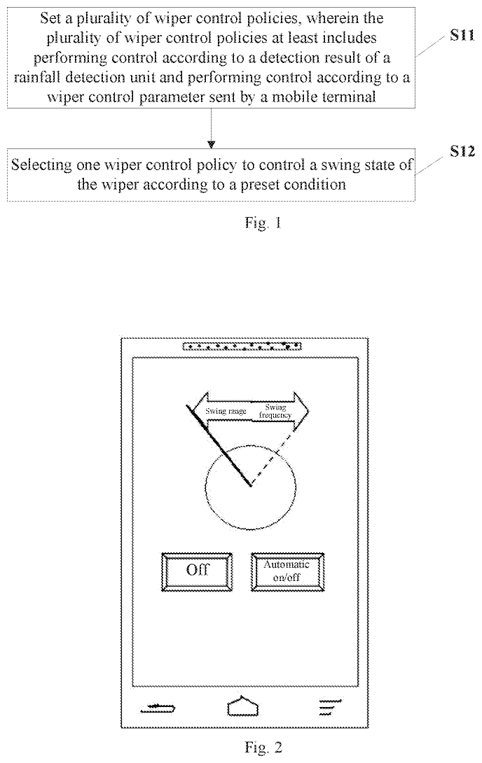

FIG. 1 is a flow chart of a wiper control method provided by an embodiment of the present disclosure. Referring to FIG. 1, the method specifically includes the control steps as follows.

In S11, a plurality of wiper control policies are set, the plurality of wiper control policies at least including controlling according to a detection result of a rainfall detection unit and controlling according to a wiper control parameter sent by a mobile terminal.

Specifically, the wiper control policy may be to perform a wireless control on the wiper, such as controlling according to the wiper control parameter sent by the mobile terminal, or to perform a wired control on the wiper, such as controlling according to the detection result of the rainfall detection unit. The rainfall detection unit includes, but is not limited to, a pressure sensor and an infrared sensor.

In S12, one wiper control policy is selected to control a swing state of the wiper according to a preset condition.

Specifically, when selecting the wiper control policy, the wiper control policy may be selected according to a turn-on condition of the wireless connection unit, or may be selected according to a working condition of the rainfall detection unit, the need to adopt a more precise control mode and other factors, or one wiper control policy may be reasonably selected taking all factors into consideration. In addition, the forgoing swing state of the wiper includes, but is not limited to, a swing frequency of the wiper, a swing amplitude of the wiper and a length of the wiper.

Further, before controlling the swing state of the wiper according to the detection result of the rainfall detection unit, an amount of the rainfall is detected through the rainfall detection unit firstly; then it is judged whether the rainfall satisfies a set threshold according to the detection result; and if the rainfall satisfies the set threshold, the swing state of the wiper is controlled correspondingly according to the detection result of the rainfall detection unit.

When detecting the amount of the rainfall through the rainfall detection unit, the amount of the rainfall may be determined by detecting a raindrop weight and a raindrop density, and then the swing state of the wiper may be adjusted according to the amount of the rainfall. In the embodiment, it is explained by taking a pressure sensor as the rainfall detection unit for example.

When detecting the raindrop weight, a specific detecting process is as follows:

When a raindrop falls to a physical position of a point (X, Y) in a certain area of the sensor, the sensor detects a variation of a resistance value (or a capacitance value) thereof to obtain a resistance (or capacitance) variance, then converts the resistance (or capacitance) variance into a voltage (or current) variance representing an X-coordinate and a Y-coordinate, and indirectly converts a weight variance of one raindrop from the voltage (or current) variance finally. If the weight variance is positive and the variance is large, then it is deemed that the current rainfall is increased a lot, and the swing frequency or the swing amplitude of the wiper is adjusted to a corresponding gear position, to provide a better view for the user. If the weight variance is negative and the variance is small, then it is deemed that the rainfall is decreased a lot, and the swing frequency or the swing amplitude of the wiper is adjusted to a corresponding gear position, to satisfy the normal demands, save the electricity and minimize the impact on the view of the user.

Specifically, the pressure sensor reflects the weight of one raindrop as a resistance value (or capacitance value), or converts the resistance value (or the capacitance value) into a voltage value (or a current value), and uses the voltage value (or the current value) as a detection means to judge the amount of the current rainfall. A relationship between the weight of one raindrop and the voltage value or current value is: the gravity of one raindrop G=kV (or kI), i.e., the weight of the raindrop is directly proportional to the voltage value or current value, where G represents a pressure generated by one raindrop on the pressure sensor and may also be understood as the gravity of the raindrop itself, and the weight of the raindrop may be converted from the gravity; and k is a proportional coefficient. The coefficient may be linear or non-linear, which is related to a characteristic of the sensor. When the characteristic of the sensor is determined, the proportional coefficient is also determined accordingly.

When detecting the raindrop density, a specific detecting process is as follows:

The pressure sensor detects a time point when the previous raindrop falls down to the sensor and a time point when the next raindrop falls down to the sensor, thereby obtaining a time difference Δt between the previous raindrop and the next raindrop, and then judging the raindrop density. Alternatively, the pressure sensor detects an intermittent pressure, determines the drop speed of the raindrop according to a pressure change period, and then determines the raindrop density.

Through the raindrop gravity G and the time difference Δt of the raindrop, the pressure sensor may sense the amount of the rainfall in the current environment, and then reasonably adjust the swing state of the wiper according to the raindrop weight and the raindrop density detected, so as to achieve the intelligent wiper. A relationship between the swing frequency of the wiper and the raindrop weight and the raindrop density is that: the swing frequency of the wiper f=β[G, Δt], i.e., the swing frequency f is proportional to the raindrop weight (raindrop gravity) and inversely proportional to the raindrop density; that is, when the raindrop weight is larger than a certain value and the raindrop weight is larger and larger (i.e., the raindrop weight is larger and larger), the swing frequency of the wiper increases with the increase of the raindrop weight. When the raindrop drops faster and faster (i.e., the time difference Δt of the raindrop becomes smaller and smaller), the swing frequency of the wiper increases with the decrease of the time difference Δt of the raindrop. β is a relationship formula between the raindrop weight (raindrop gravity G) and the time difference of the raindrop.

Taking both the raindrop density and the raindrop weight detected by the pressure sensor into account, the reasonable swing frequency and swing amplitude are determined to control the wiper. Specifically, it is assumed that a raindrop weight range corresponds to one swing frequency and one swing angle, and a raindrop density range corresponds to one swing frequency and one swing angle, when the raindrop weight and the raindrop density detected do not correspond to the same swing frequency, one swing frequency may be selected in a compromise, or the swing frequency corresponding to the raindrop density is prevailing according to the settings, or the swing frequency corresponding to the raindrop weight is prevailing, so as to provide a clearer view for the user. The raindrop density is reflected by the time difference.

It is assumed that a time difference range between two adjacent raindrops falling down to the sensor includes 0.8 to 1 s, 0.5 to 0.8 s and 0.3 to 0.5 s, and a swing frequency corresponding to 0.8 to 1 s is two times/s, a swing frequency corresponding to 0.5 to 0.8 s is 4 times/s, and a swing frequency corresponding to 0.3 to 0.5 s is 5 times/s; and a raindrop weight range includes 50 to 55 mg, 55 to 60 mg and 60 to 65 mg, and a swing frequency corresponding to 50 to 55 mg is two times/s, a swing frequency corresponding to 55 to 60 mg is three times/s, and a swing frequency corresponding to 60 to 65 mg is 4 times/s. Based on the above data, the time differences among four consecutive raindrops detected currently are 0.9 s, 0.7 s and 0.4 s respectively, and the weights are 50 mg, 53 mg, 58 mg and 65 mg respectively, then the swing frequency of the wiper is changed from two times/s to three times/s, and then is adjusted to four times/s. As the rainfall increases, the swing frequency of the wiper increases correspondingly, so that the user can always obtain a better view. The embodiment is only for explaining the present disclosure and is not intended to limit the present disclosure.

It should be noted that a period of time may be selected for detecting the raindrop weight and the raindrop density, or the raindrop weight and the raindrop density may be detected in a sustainable manner. When the former is adopted for detection, the power consumption of the detector is low, while when the latter is adopted for detection, the detector needs to be enabled (turned on) all the time. However, the latter has a higher detection accuracy and can adjust the swing state of the wiper more reasonably in real time.

Further, before controlling the swing state of the wiper according to the wiper control parameter sent by the mobile terminal, a wiper control parameter sent by the user is acquired through the mobile terminal firstly, or the wiper control parameter sent by the mobile terminal is received. The wiper control parameter is a parameter acquired according to the detection result of the rainfall detection unit. In other words, the user may manually set the wiper control parameter to control the swing state of the wiper, or the swing state of the wiper may be controlled by automatically setting the wiper control parameter; for example, the swing state of the wiper is automatically adjusted according to the parameter acquired from the detection result of the rainfall detection unit.

Specifically, the mobile terminal is equipped with application software specially used to control the swing state of the wiper. FIG. 2 is a schematic diagram of an application software control interface provided by the present embodiment. Referring to FIG. 2, the user may control the swing state of the wiper, such as the swing amplitude and the swing frequency through the application software, may also manually control the on-off of the wiper control device through the application software, and meanwhile, may set to automatically turn on or turn off the wiper control device. When controlling the swing state of the wiper, the application software may receive the detection result of the rainfall detection unit through a wireless receiving unit, and obtain the wiper control parameter according to the detection result; moreover, the swing state of the wiper is controlled by the user through the application software or controlled automatically by the application software according to the wiper control parameter. The wiper control parameter may either be a gear position corresponding to the swing frequency and the swing amplitude of the wiper, or a specific swing frequency and swing amplitude; in addition, the detailed description of the wiper control device mentioned above may be referred to in the embodiment and will not be elaborated here.

For the specific control process of the wiper control device by the mobile terminal, in one embodiment, after receiving the wiper control parameter set by the user, the application software in the mobile terminal sends the wiper control parameter to the wiper control device, and the wiper control device adjusts the swing state of the wiper according to the wiper control parameter. By implementing the embodiment, the user can adjust the swing state of the wiper at any time during driving, so that the operation convenience of the user is further improved.

In another embodiment, the application software in the mobile terminal receives the wiper control parameter sent by the rainfall detection unit through the wireless receiving unit, the wiper control parameter being a parameter acquired according to the detection result of the rainfall detection unit, then the application software in the mobile terminal displays the wiper control parameter on a current interface of the application software. The user triggers a wiper control operation according to the wiper control parameter, the application software sends the wiper control parameter to the wiper control device, and the wiper control device adjusts the swing state of the wiper according to the wiper control parameter. Or, the application software sends the wiper control parameter sent by the rainfall detection unit to the wiper control device directly, and a swing parameter of the wiper is adjusted automatically through the wiper control device. By implementing the embodiment, the user can adjust the swing state of the wiper more reasonably and at any time according to the parameter detected by the rainfall detection unit, and make more precise adjustments to the swing state of the wiper.

Further, in step S12, when selecting one wiper control policy to control the swing state of the wiper according to the preset condition, the preset condition may be to select the wiper control policy to control the swing state of the wiper according to whether the wireless connection unit is turned up, or may be to select the wiper control policy according to a working state of the rainfall detection unit, or to select a proper wiper control policy from the aspect of energy saving. Other existing more reasonable selecting conditions can also be used in addition to the above-mentioned preset conditions.

Specifically, if detecting that the wireless connection unit is enabled, it is selected to control the swing state of the wiper according to the wiper control parameter sent by the mobile terminal, and if detecting that the wireless connection unit is not enabled, it is selected to control the swing state of the wiper according to the detection result of the rainfall detection unit. If the current rainfall detection unit cannot detect or cannot detect accurately due to line failure, device aging or other reasons, the swing state of the wiper is controlled according to the wiper control parameter sent by the mobile terminal; and if the current rainfall detection unit can normally detect the rainfall or the detection result has little deviation, the swing state of the wiper is directly controlled according to the detection result detected by the rainfall detection unit. If the user wants to reduce the power consumption, the wiper control device may be enabled through the application software, and then the swinging state of the wiper may be controlled according to the wiper control parameter sent by the mobile terminal, thus avoiding the wiper control device from being in a working state all the time.

According to the wiper control method provided by the embodiment, the plurality of wiper control policies are set, and then the reasonable wiper control policy is selected to control the swing state of the wiper according to the demand of the user or the condition of the device, so that the wiper always works in a more reasonable swing state, thereby ensuring the user to obtain a clearer view. At the same time, by setting the plurality of wiper control policies, the wiper control triode is more flexible and humanized, thus providing the user with good use experience.

### Second Embodiment

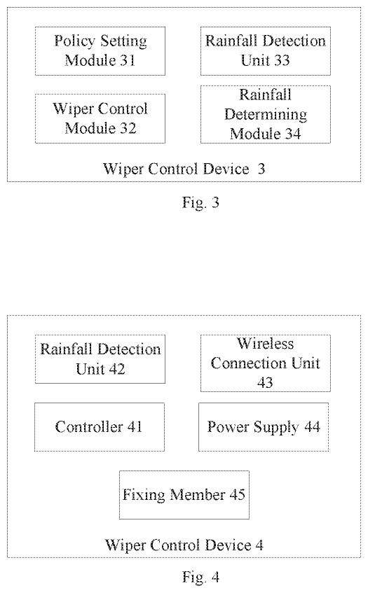

The present embodiment is a device embodiment corresponding to the first embodiment, and provides a wiper control device. FIG. 3 is a schematic diagram of a wiper control device provided by the present embodiment. The wiper control device includes:

a policy setting module 31 configured to set a plurality of wiper control policies, the plurality of wiper control policies at least including a control according to a detection result of a rainfall detection unit and a control according to a wiper control parameter sent by a mobile terminal; and

a wiper control module 32 configured to select one wiper control policy to control a swing state of the wiper according to a preset condition.

Further, the wiper control device further includes:

a rainfall detection unit 33 configured to, before controlling the swing state of the wiper according to the detection result, detect the rainfall; and

a rainfall determining module 34 configured to determine whether the rainfall satisfies a set threshold according to the detection result; and if the rainfall satisfies the set threshold, proceed the step of controlling the swing state of the wiper according to the detection result of the rainfall detection unit.

The rainfall detection unit 33 is also configured to detect at least one of a raindrop weight and a raindrop density to determine the rainfall.

The forgoing rainfall detection unit 34 has the function of detecting the amount of the rainfall using a pressure sensor or an infrared sensor. The functions of the policy setting module 31, the wiper control module 32 and the rainfall determining module 34 mentioned above may be achieved by a controller or a processor.

Further, in the policy setting module 31, the wiper control policy may be to perform wireless control on the wiper, such as controlling according to the wiper control parameter sent by the mobile terminal, or to perform wired control on the wiper, such as controlling according to the detection result of the rainfall detection unit.

In the wiper control module 32, when selecting the wiper control policy, the wiper control policy may be selected according to the on-off condition of the wireless connection unit, or may be selected according to the working conditions of the rainfall detection unit, the need to adopt a more precise control mode and other factors, or one wiper control policy may be reasonably selected taking all factors into consideration. In addition, the forgoing swing state of the wiper includes, but is not limited to, a swing frequency, a swing amplitude and a length of the wiper, etc.

Specifically, when detecting the amount of the rainfall through the rainfall detection unit, the rainfall may be determined by detecting a raindrop weight and a raindrop density, and then the swing state of the wiper may be adjusted according to the rainfall. In the embodiment, it is explained by taking a pressure sensor as the rainfall detection unit for example.

Taking both the raindrop density and the raindrop weight detected by the pressure sensor into account, the reasonable swing frequency and swing amplitude are determined to control the wiper. Specifically, it is assumed that a raindrop weight range corresponds to one swing frequency and one swing angle, and a raindrop density range corresponds to one swing frequency and one swing angle, when the raindrop weight and the raindrop density detected do not correspond to the same swing frequency, one swing frequency may be selected in a compromise, or the swing frequency corresponding to the raindrop density is prevailing according to the settings, or the swing frequency corresponding to the raindrop weight is prevailing, so as to provide a clearer view for the user. The raindrop density is reflected by a time difference.

It should be noted that a period of time may be selected for detecting the raindrop weight and the raindrop density, or the raindrop weight and the raindrop density may be detected in a sustainable manner. When the former is adopted for detection, a detector has a lower power consumption, while when the latter is adopted for detection, the detector needs to be enabled all the time, but the latter has a higher detection accuracy and can adjust the swing state of the wiper more reasonably in real time.

Further, the preset condition involved in the wiper control module 32 may be to select the wiper control policy to control the swing state of the wiper according to whether the wireless connection unit enabled, or may be to select the wiper control policy according to a working state of the rainfall detection unit, or to select a proper wiper control policy from the aspect of energy saving. Other existing more reasonable selection conditions may also be used in addition to the above-mentioned preset conditions.

The wiper is adjusted adaptively according to the rainfall. The wiper control mode is more flexible and humanized by adaptively adjusting the wiper according to the rainfall and providing various wiper control policies for the user.

### Third Embodiment

With reference to FIG. 4, the present embodiment provides a wiper control device. The wiper control device includes: a controller 41, a rainfall detection unit 42 and a wireless connection unit 43, the controller 41 being respectively connected with the rainfall detection unit 42 and the wireless connection unit 43, wherein the rainfall detection unit 42 includes, but is not limited to, a pressure sensor and an infrared sensor; and the wireless connection unit 43 includes, but is not limited to, a WIFI unit, a bluetooth device and a RE communication device.

The controller 41 is configured to set a plurality of wiper control policies, the plurality of wiper control policies at least including a control according to a detection result of the rainfall detection unit 42 and a control according to a wiper control parameter sent by a mobile terminal; and is also configured to select one wiper control policy to control a swing state of the wiper according to a preset condition. The wiper control policy of controlling according to the wiper control parameter sent by the mobile terminal is based on the situation that the mobile terminal establishes a communication connection relationship with the wiper control device through the wireless connection unit 43.

Further, when selecting the wiper control policy, the preset condition may be to judge whether the wireless connection unit 43 is enabled. Specifically, if the wireless connection unit 43 is enabled, the wiper control device establishes a communication connection relationship with the mobile terminal through the wireless connection unit 43, and the controller 41 is configured to receive the wiper control parameter sent by the mobile terminal through the wireless connection unit 43 and controls the swing state of the wiper according to the wiper control parameter. If the wireless connection unit 43 is not enabled, the controller 41 is configured to control the swing state of the wiper according to the detection result of the rainfall detection unit 42.

A high-performance battery is used to supply power for continuous operation. As an optimization measure, it is also possible to use a wireless charging mode to supply power to the wiper control device by a high-performance battery at any time for continuous operation. As an optimization measure, it is also possible to use a wireless charging mode to charge the wiper control device at any time to improve the service time. A fixing member 45 is configured to fix the wiper control device on the window glass, and to ensure no loss fixing as much as possible, large fixing force and convenient disassembly. In the embodiment, strong magnets may suck on the glass from inside and outside, while other fixing methods well known in the art may also be used.

The wiper is arranged on the wiper control device, the wiper has a good wiping effect and the length of the wiper may be adjusted manually or automatically. In addition, when the wiper is controlled by the wiper control device, the length of the wiper may be adjusted by the detection result of the rainfall detection unit, or the length of the wiper may be manually adjusted by the user, or the length of the wiper may be adjusted by the user through application software, so as to adapt to different swing space requirements and have a perfect wiping effect.

The wiper control device provided by the present embodiment is simple, and is convenient to carry, can be placed at a reasonable position of an automobile window according to the needs, can be placed at a front window glass and a rear window glass, and can also be placed at any position of a side window glass, so as to provide a clear view for the user to the maximum extent. Meanwhile, the user can also control the swing state of the wiper of the wiper control device through the wireless connection unit, or automatically control the swing state of the wiper through the detection result of the rainfall detection unit, so as to provide better use experience for the user.

### Fourth Embodiment

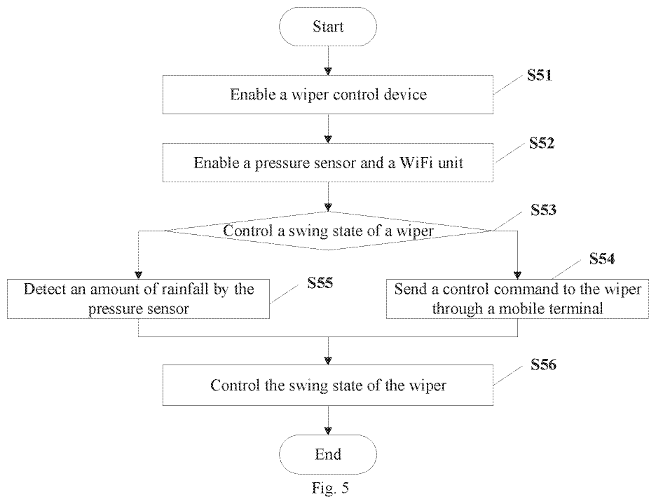

Based on the wiper control device provided in the third embodiment, the present embodiment further explains a selection process of the wiper control mode, wherein a pressure sensor is taken as an example of the rainfall detection unit and a wireless WWI unit is taken as an example of the wireless connection unit. The mobile terminal establishes a communication connection relationship with the wiper control device through the WIFI unit. On this premise, referring to FIG. 5, which is a flow chart of selecting a control mode provided by the embodiment, the specific selecting steps are as follows:

In S51, the wiper control device is enabled.

To be specific, when the wiper control device is powered by a power supply, the wiper control device may be enabled manually by the user or enabled automatically within a set time period.

In S52, the pressure sensor and the WiFi unit are enabled.

Specifically, the pressure sensor is enabled to detect the amount of the current rainfall, and the WiFi unit is enabled to establish a communication connection relationship between the mobile terminal and the wiper control device.

In S53, it is judged whether the swing state of the wiper is controlled through the WiFi unit; if yes, step S54 is executed, and if no, step S55 is executed.

Specifically, it is also possible to judge whether to control the wiper through other judging conditions, such as judging whether the WiFi unit is enabled. When judging whether the wiper is controlled by the wireless WiFi unit, the control mode may be selected by the user or selected automatically according to the usage habits or historical operation records of the user.

In S54, the user sends a control command to the wiper control device through the wireless WiFi unit to control the swing state of the wiper on the mobile terminal, and executes step S56.

In step S55, the pressure sensor detects the amount of the rainfall.

Specifically, a raindrop weight and/or a raindrop density may be detected, and the amount of the rainfall is determined according to the raindrop weight and/or the raindrop density.

In S56, the wiper control device controls the swing state of the wiper.

Specifically, the swing state of the wiper may be controlled according to the control command of the mobile terminal, or may be controlled according to the rainfall detected by the pressure sensor. The swing state includes, but is not limited to, a swing frequency, a swing amplitude and a length of the wiper.

It will be apparent to those skilled in the art that the above-described modules or steps of the invention may be implemented by a general purpose computing device which may be focused on a single computing device or distributed over a plurality of computing devices, which may optionally be implemented by a program code executable by the computing device, so that they may be stored in a storage medium (ROM/RAM, magnetic disk, optical disc) for execution by the computing device and, in some cases, the steps shown or described may be performed in sequence different from here; or they are separately made into each integrated circuit module, or multiple modules or steps in them are made into a single integrated circuit module. Thus, the present disclosure is not limited to any particular combination of hardware and software.

The foregoing contents are further detailed descriptions of the embodiments of the present disclosure with reference to the specific embodiments, and it should not be considered that the embodiments of the present disclosure are only limited to these descriptions. For those having ordinary skills in the art, some simple deduction or replacement can be made without departing from the concept of the present disclosure, which shall all be included within the range of protection of the invention.

### INDUSTRIAL APPLICABILITY

in the wiper control process of the embodiments of the present disclosure, the plurality of wiper control policies are set, the plurality of wiper control policies at least including controlling according to the detection result of the rainfall detection unit and controlling according to the wiper control parameter sent by the mobile terminal; and then, one wiper control policy is selected to control the swing state of the wiper according to the preset condition. By implementing the wiper control mode provided by the embodiments of the present disclosure, the wiper can be adjusted adaptively according to the rainfall, and meanwhile, the wiper control mode is more flexible and humanized by providing various wiper control policies for the user. In addition, the wiper control device provided by the embodiments is simple and convenient, and can be arranged at front and rear windows, side windows and other places of the automobile, providing a clearer field of view for the user, and further ensuring that the user can accurately judge the road conditions when driving in the rain, thereby improving the use experience of the user.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in scope with the present disclosure. Additionally, while various embodiments of the present disclosure have been described, it is to be understood that aspects of the present disclosure may include only some of the described embodiments or combinations of the various embodiments. Accordingly, the present disclosure is not to be seen as limited by the foregoing description.

1.-11. (canceled)

12. A wiper control method, comprising:
setting a plurality of wiper control policies, the plurality of wiper control policies at least including a control according to a detection result of a rainfall detection unit and a control according to a wiper control parameter sent by a mobile terminal; and
selecting one wiper control policy to control a swing state of the wiper according to a preset condition.

13. The wiper control method according to claim 12, wherein before controlling the swing state of the wiper according to the detection result of the rainfall detection unit, the method further comprises:
detecting the rainfall through the rainfall detection unit;
determining whether the rainfall satisfies a set threshold according to the detection result; and
when the rainfall satisfies the set threshold, proceeding the step of controlling the swing state of the wiper according to the detection result of the rainfall detection unit.

14. The wiper control method according to claim 13, wherein the detecting the rainfall through the rainfall detection unit comprises:
detecting at least one of a raindrop weight and a raindrop density through the rainfall detection unit to determine the rainfall.

15. The wiper control method according to claim 12, wherein before controlling the swing state of the wiper according to the wiper control parameter sent by the mobile terminal, the method further comprises:
acquiring the wiper control parameter sent by a user through the mobile terminal; or
receiving the wiper control parameter sent by the mobile terminal, the wiper control parameter being a parameter acquired according to the detection result of the rainfall detection unit.

16. The wiper control method according to any one of claim 12, wherein the selecting one wiper control policy to control the swing state of the wiper according to the preset condition comprises:
determining whether a wireless connection unit is enabled;
if the wireless connection unit is enabled, controlling the swing state of the wiper according to the wiper control parameter sent by the mobile terminal; and
if the wireless connection unit is not enabled, controlling the swing state of the wiper according to the detection result of the rainfall detection unit.

17. The wiper control method according to any one of claim 15, wherein the selecting one wiper control policy to control the swing state of the wiper according to the preset condition comprises:
determining whether a wireless connection unit is enabled;
if the wireless connection unit is enabled, controlling the swing state of the wiper according to the wiper control parameter sent by the mobile terminal; and
if the wireless connection unit is not enabled, controlling the swing state of the wiper according to the detection result of the rainfall detection unit.

18. The wiper control method according to any one of claim 12, wherein the swing state comprises a swing frequency of the wiper, a swing amplitude of the wiper and a length of the wiper.

19. The wiper control method according to any one of claim 15, wherein the swing state comprises a swing frequency of the wiper, a swing amplitude of the wiper and a length of the wiper.

20. A wiper control device, comprising:
a policy setting module configured to set a plurality of wiper control policies, the plurality of wiper control policies at least comprising a control according to a detection result of a rainfall detection unit and a control according to a wiper control parameter sent by a mobile terminal; and
a wiper control module configured to select one wiper control policy to control a swing state of the wiper according to a preset condition.

21. The device for controlling a wiper according to claim 20, further comprising:
a rainfall detection unit configured to, before controlling the swing state of the wiper according to the detection result, detect the rainfall; and
a rainfall determining module configured to determine whether the rainfall satisfies a set threshold according to the detection result; and when the rainfall satisfies the set threshold, proceed the step of controlling the swing state of the wiper according to the detection result of the rainfall detection unit.

22. The wiper control device according to claim 21, wherein the rainfall detection unit is configured to detect at least one of a raindrop weight and a raindrop density to determine the rainfall.

23. A wiper control device, comprising: a controller, a rainfall detection unit and a wireless connection unit, the controller being respectively connected with the rainfall detection unit and the wireless connection unit; and
the controller being configured to set a plurality of wiper control policies, the plurality of wiper control policies at least comprising a control according to a detection result of the rainfall detection unit and a control according to a wiper control parameter sent by a mobile terminal; and also configured to select one wiper control policy to control a swing state of the wiper according to a preset condition.

24. The wiper control device according to claim 23, wherein:
if the wireless connection unit is enabled, the device for controlling a wiper establishes a communication connection relationship with the mobile terminal through the wireless connection unit, and the controller is configured to receive the wiper control parameter sent by the mobile terminal through the wireless connection unit, and control the swing state of the wiper according to the wiper control parameter; and
if the wireless connection unit is not enabled, the controller is configured to control the swing state of the wiper according to the detection result of the rainfall detection unit.
